(19) United States
(12) Patent Application Publication
(10) Pub. No.: US 2025/0353196 A1
(43) Pub. Date: Nov. 20, 2025

(54) FOLDABLE CUTTING TOOL

(71) Applicant: Tienchi Hu, Taipei (TW)

(72) Inventor: Tienchi Hu, Taipei (TW)

(21) Appl. No.: 19/212,737

(22) Filed: May 20, 2025

Related U.S. Application Data
(60) Provisional application No. 63/649,457, filed on May 20, 2024.

(51) Int. Cl. B26B 1/04

(52) U.S. Cl. CPC B26B 1/042

(57) ABSTRACT

A pivoting shaft extending in a first direction is combined with the first pivoting member and the second pivoting member. The blade structure or the handle structure can be turned about the first direction to be switched between an unfolded working state and a folded storage state; and a locking and unlocking structure disposed in a first accommodation space of the handle structure, and rotatable about the second direction. The locking and unlocking structure is rotated to a first position to be in contact with a first part of the blade structure to secure the blade structure in the unfolded working state, and rotated to a second position different from the first direction to have a retracting part facing a second part of the blade structure, wherein the second part of the blade structure can pass the retracting part of the locking and unlocking structure to enter the folded storage state.

### CROSS-REFERENCE TO RELATED APPLICATIONS

The present application is a nonprovisional application claiming benefit from a prior-filed provisional application bearing a Ser. No. 63/649,457 and filed May 20, 2024, the entity of which is incorporated herein for reference.

### FIELD OF THE INVENTION

The present invention relates to a foldable tool, and more particularly to a foldable cutting tool.

### BACKGROUND OF THE INVENTION

In daily lives and outdoor activities, tools with sharp blades such as knives, saws, etc., are commonly used for conducting a variety of functions such as unboxing, cutting, drilling, scratching, etc. For example, bags, ropes, paper, food, and many other items can be broken or cut off with such tools. For safety or portability, a cutting tool with a sharp blade may be designed to be foldable so that the sharp blade can be hidden into a handle of the tool when the tool is not in use.

On the contrary, when the tool is in use, it is unfolded to expose the sharp blade so that a user can hold the handle of the tool, and use the sharp blade to perform required functions. For enabling the user to effectively exert a force onto the tool with the exposed blade, and avoiding the sharp blade from wobbling, it is necessary to provide a locking mechanism for the tool to fix the sharp blade in position when the tool is unfolded, and keep the sharp blade stably exposed.

A variety of foldable knives with locking mechanisms have been developed. However, conventional foldable knives are generally equipped with complicated locking mechanisms for clamping the blades. As a result, the blades of such tools might be worn out after a long-term use or the clamping force might be gradually weakened during clamping. Such clamping types of locking mechanisms have problems in reliability.

### SUMMARY OF THE INVENTION

Therefore, an object of the present invention is to provide a foldable cutting tool with an improved locking mechanism.

The present invention relates to a foldable cutting tool, which includes a blade structure including a first pivoting member; a handle structure including a second pivoting member; a pivoting shaft extending in a first direction and combined with the first pivoting member and the second pivoting member, wherein the blade structure or the handle structure can be turned about an axis in parallel to the first direction to be switched between an unfolded working state and a folded storage state; and a locking and unlocking structure disposed in a first accommodation space of the handle structure, and rotatable about an axis in parallel to a second direction, wherein the locking and unlocking structure is rotated to a first position to be in contact with a first part of the blade structure to secure the blade structure in the unfolded working state, and the locking and unlocking structure is rotated to a second position different from the first direction to have a retracting part facing a second part of the blade structure, wherein the second part of the blade structure can pass the retracting part of the locking and unlocking structure to enter the folded storage state.

### BRIEF DESCRIPTION OF THE DRAWINGS

The above contents of the present invention will become more readily apparent to those ordinarily skilled in the art after reviewing the following detailed description and accompanying drawings, in which:

FIG. 1A is a schematic diagram illustrating a locked configuration of a foldable cutting tool according to an embodiment of the present invention.

FIG. 1B, FIG. 1C and FIG. 1D are schematic diagrams illustrating unlocked configurations, which are sequentially shown in a folding process of the foldable cutting tool of FIG. 1A.

FIG. 2A and FIG. 2B are a schematic diagram illustrating a room formed in the handle structure for accommodating an assembly of the locking and unlocking structure and the lock auxiliary structure according to an embodiment of the present invention.

FIG. 3A and FIG. 3B are schematic diagrams illustrating collaboration of the lock auxiliary structure with the locking and unlocking structure shown in FIG. 2A.

FIG. 4A, FIG. 4B and FIG. 4C are schematic diagrams illustrating the operations of the locking and unlocking structure and the lock auxiliary structure to implement the locking configuration shown in FIG. 1A and the unlocking configurations shown in FIGS. 1B and 1C, respectively.

FIG. 4D is a schematic diagram illustrating a stopper member of a foldable cutting tool according to an embodiment of the present invention.

### DETAILED DESCRIPTION OF THE PREFERRED EMBODIMENT

The invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

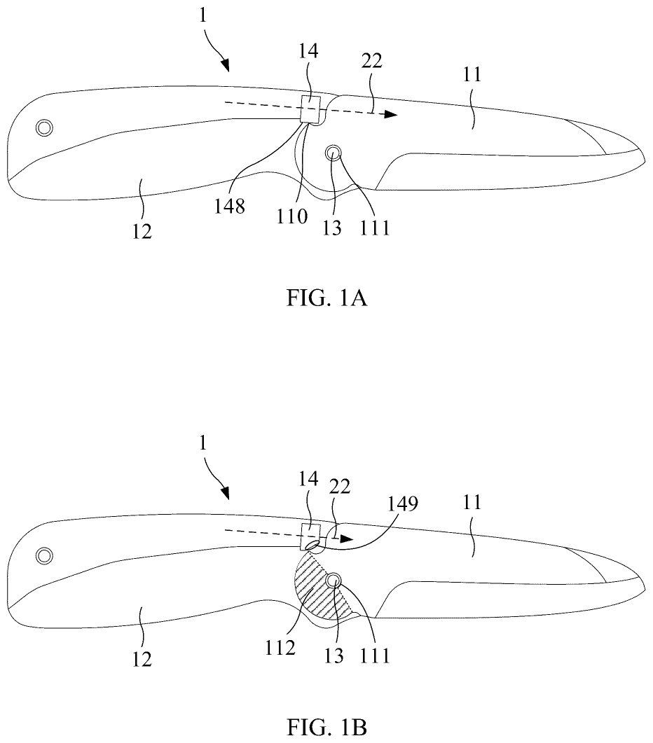

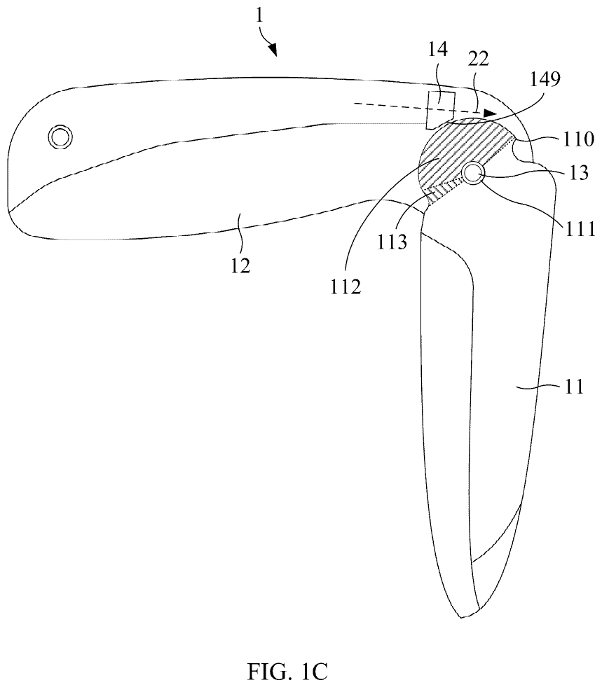

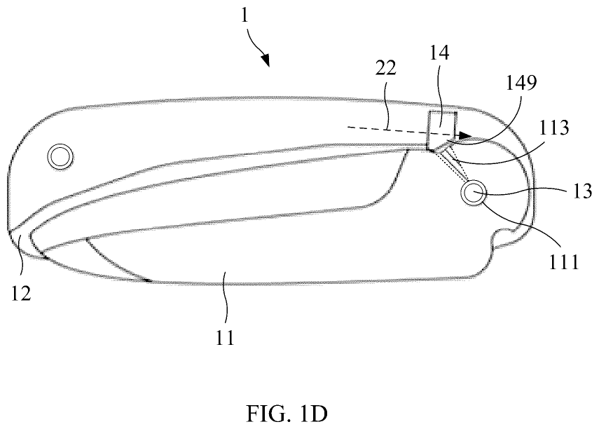

Please refer to FIG. 1A, which schematically illustrates a simplified structure of a foldable cutting tool according to an embodiment of the present invention. In this embodiment, the foldable cutting tool is exemplified as, but not limited to, a foldable knife 1. The principle of the present invention may also be applied to any other suitable foldable cutting tool, e.g., foldable saw, or any other suitable foldable tool with a sharp tip or edge to be hidden by way of folding. The foldable knife 1 includes a blade structure 11, a handle structure 12, a pivoting structure 13, and a locking and unlocking structure 14. The blade structure 11 is pivotably connected to the handle structure 12 via the pivoting structure 13. The foldable knife 1 shown in FIG. 1A has a locked configuration, in which a protruding part 148 of the locking and unlocking structure 14 securely engages with a hook part 110 of a tail surface of the blade structure 11.

On the other hand, FIG. 1B, FIG. 1C and FIG. 1D schematically illustrate unlocked configurations sequentially shown in a folding process of the foldable cutting tool. To enter the unlocked configurations, the protruding part 148 of the locking and unlocking structure 14 shown in FIG. 1A needs to be disengaged from the hook part 110 of the blade structure 11. In an embodiment, the disengagement of the protruding part 148 of the locking and unlocking structure 14 from the hook part 110 of the blade structure 11 can be conducted by exerting an external force to rotate the locking and unlocking structure 14. The external force may be manually exerted by the user or it may also be provided through an electric power such as a motor, depending on practical designs. Meanwhile, a retracting part 149 of the locking and unlocking structure 14 is turned to face the hook part 110 of the blade structure 11 (FIG. 1B). Afterwards, while the user is turning the blade structure 11 toward the handle structure 12, the retracting part 149 of the locking and unlocking structure 14 relatively slides along an arc part 112 of the tail surface of the blade structure 11 (FIG. 1C) until the blade structure 11 is hidden in the handle structure 12 (FIG. 1D). The retracting part 149, for example, may be implemented with a bevel plane, a recess, or a trench, which allows the arc part 112 to pass therethrough. During the sliding action of the retracting part 149 along the arc part 112, the retracting part 149 may be in contact with or spaced from the arc part 112, depending on design options, and the blade structure 11 can be smoothly turned without or with little resistance. For example, if the distances from points of the arc part 112 to the pivoting structure 13 are less than the distance between the retracting part 149 and the pivoting structure 13, no contact between the retracting part 149 and the arc part 112 would occur. The distances from points of the arc part 112 to the pivoting structure 13 may be the same or gradually changing, depending on practical designs. In another embodiment, the tail surface of the blade structure further includes a reduced arc part 113 disposed at a side of the arc part 112 opposite to the hook part 110. The distances from points of the reduced arc part 113 to the pivoting structure 13 are slightly less than the distances between points of the arc part 112 and the pivoting structure 13. Therefore, when the blade structure 11 is completely folded into the handle structure 12, as shown in FIG. 1D, the locking and unlocking structure 14 engages with the reduced arc part 113 to secure the storage configuration.

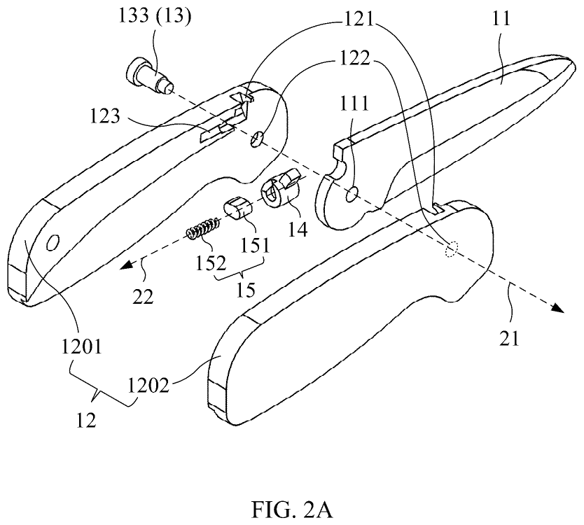

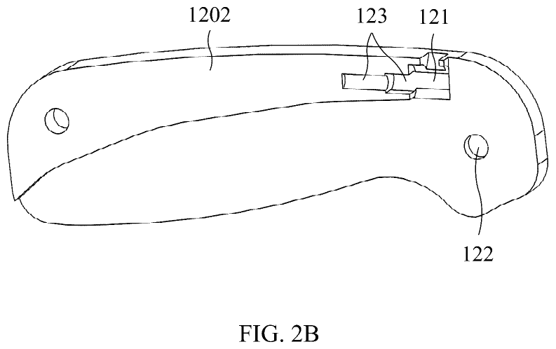

Hereinafter, examples of elements that can perform the above-described functions are given with reference to the exploded view shown in FIG. 2A. As shown in FIG. 2A, dissembled parts of the foldable knife 1 are schematically shown, wherein the foldable knife 1 further includes a lock auxiliary structure 15. In this embodiment, the blade structure 11 and the handle structure 12 are configured as three plates extending substantially in parallel to one another, and the plate of the blade structure 11 is clamped between two plates 1201 and 1202 of the handle structure 12. The two plates 1201 and 1202 may be integrated into one piece and an accommodation room for receiving the folded blade structure 11 is reserved in the handle structure 12. The blade structure 11 and the handle structure 12 are assembled by using the pivoting structure 13 to combine the three plates. The pivoting structure 13 includes a first pivoting member 111 disposed in the blade structure 11, a second pivoting member 122 disposed in each of the plates 1201 and 1202 of the handle structure 12, and a pivoting shaft 133. The first pivoting member 111 may be a through hole, and the second pivoting members 122 may be two opposite recesses or through holes for accommodating therein or penetrating therethrough ends of the pivoting shaft 133. In the assembled knife 1, a length of the pivoting shaft 133 extends in a first direction 21, and lengths of the plate 111 of the blade structure 11 and the plates 1201 and 1202 of the handle structure 12 extend in a second direction 22 perpendicular to the first direction 21. The locking and unlocking structure 14 is disposed near the blade structure 11 and selectively engages with the tail surface of the blade structure 11, as described above. In this embodiment, the lock auxiliary structure 15 includes a push member 151 and a resilient member 152, which urges the push member 151 to sustain against the locking and unlocking structure 14 in the locked configuration, thereby further securing the engagement between the protruding part 141 of the locking and unlocking structure 14 and the hook part 110 of the tail surface of the blade structure 11 in the locked configuration.

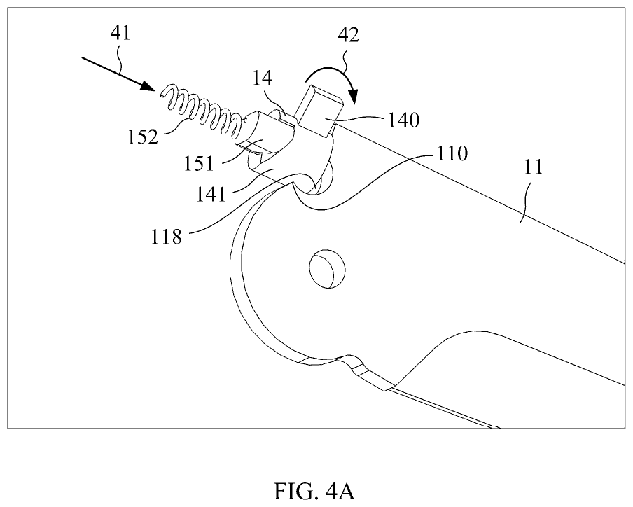

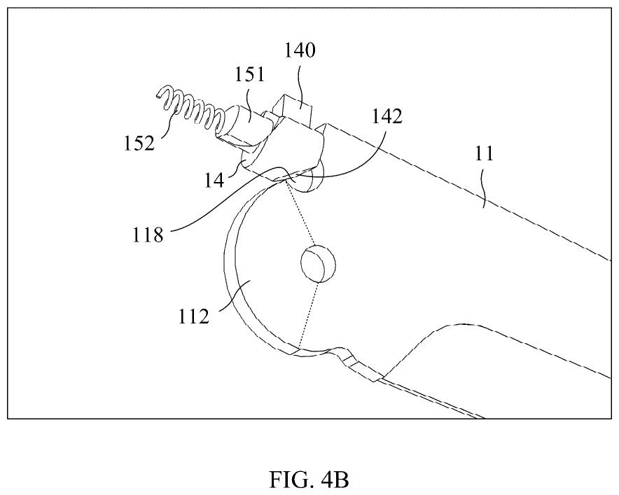

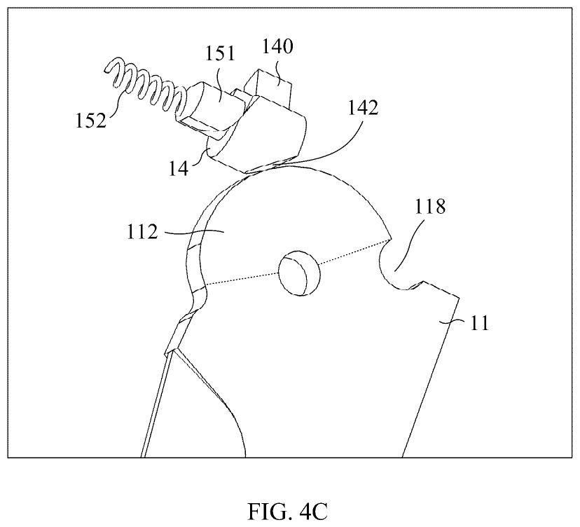

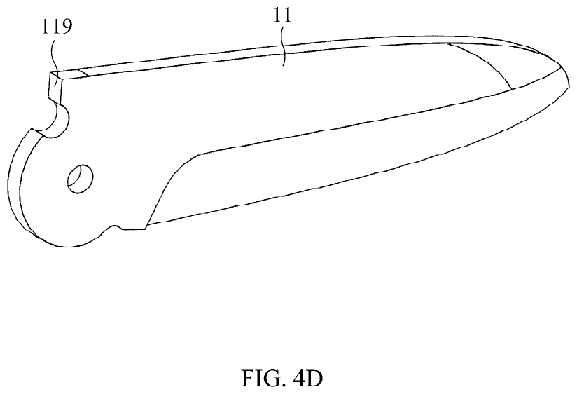

In an embodiment, the locking and unlocking structure 14 is shaped like a cylinder with a cut corner so as to have a circumferential surface 141 functioning as the protruding part 148 and a bevel surface 142 functioning as the retracting part 149. Furthermore, the locking and unlocking structure 14 includes a stick 140, or a bump of any other suitable shape, disposed at a surface other than the surfaces 141 and 142. The user can rotate the stick 140 clockwise or counterclockwise about a lengthwise axis of the locking and unlocking structure 14. The lengthwise axis, for example, may extend in the second direction 22 or may be slightly tilted from the second direction 22, depending on practical designs. By rotating the stick 140, the circumferential surface 141 (protruding part 148) or the bevel surface 142 (retracting part 149) can be selected to face the hook part 110 of the blade structure 11, thereby switching the locked and unlocked configurations. For example, FIG. 4A schematically illustrates the locked configuration that the circumferential surface 141 (protruding part 148) engages with the hook part 110 of the blade structure 11, and FIG. 4B schematically illustrates the unlocked configuration that the bevel surface 142 (retracting part 149) faces the hook part 110 of the blade structure 11. For facilitating manual rotation, a frictional texture may be optionally added to the surface of the stick 140. In an embodiment, the cylinder is a substantially flat cylinder. That is, the aspect ratio (a ratio of thickness to diameter) is smaller than or equal to 1. Such a structure can have an enhanced structural strength. For further enhancing the structural strength, the cylinder may be made of a solid material or a porous material.

Furthermore, FIG. 2B schematically illustrates a room for accommodating an assembly of the locking and unlocking structure 14 and the lock auxiliary structure 15 included in the foldable knife 1. The room is preferably disposed in the handle structure 12 near the tail surface of the blade structure 11. The room includes two halves of trenches, one in the plate 1201 and the other in the plate 1202, which are combined to suitably accommodate the assembly of the locking and unlocking structure 14 and the lock auxiliary structure 15. However, a space should be reserved in the room for the stick 140 to turn clockwise and counterclockwise. A front portion of the room is an accommodation space 121 for the locking and unlocking structure 14 and a rear portion of the room is an accommodation space 123 for the lock auxiliary structure 15.

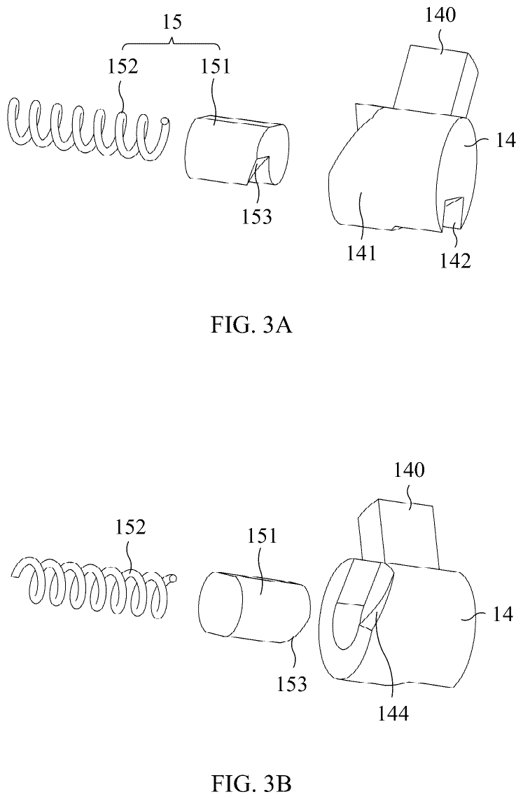

FIG. 3A and FIG. 3B are schematic diagrams illustrating a collaboration example of the lock auxiliary structure 15 with the locking and unlocking structure 14. In this embodiment, the locking and unlocking structure 14 has a contact plane 144 on a surface different from the surfaces 141, 142 selectively facing the blade structure 11 and the surface where the stick 140 is disposed. Correspondingly, the push member 151 of the lock auxiliary structure 15 has a contact plane 153 aligned with the contact plane 144. For example, the contact plane 144 and the contact plane 153 may be spiral planes or inclined planes, which are in contact with or engageable with each other. Accordingly, while the resilient member 152 urges the push member 151 to move forwards and keep on pushing against the locking and unlocking structure 14, the spiral plane 144 slides along the spiral plane 153 and drives the locking and unlocking structure 14 to rotate.

In other words, the lock auxiliary structure 15 provides a rotational restoring force to the locking and unlocking structure 14 to rotate the locking and unlocking structure 14 in a specific rotational direction, e.g., clockwise, toward a position that the circumferential surface 141 of the locking and unlocking structure 14 contacts the hook part 110 of the blade structure 11, thereby securing the locked configuration as shown in FIG. 4A. The hook part 110 is, for example, a protruding portion of a notch 118 formed on the tail surface of the blade structure 11. In the locked configuration, the locking and unlocking structure 14 is pushed by the restoring force provided by the compression spring 152 to contact the hook part 110 of the blade structure 11 with its circumferential surface 141 so as to create a highly reliable locking mechanism and indeed achieve the objectives of the invention. Furthermore, as shown in FIG. 4D, the blade structure 11 further includes an over-rotation limiting structure 119, which cooperates with the locking and unlocking structure 14 to prevent the blade structure 11 from being over-rotated opposite to the folding direction.

In an embodiment, the resilient member 152 may be a compression spring. In another embodiment, the push member 151 and the resilient member 152 may be substituted with a torsion spring (not shown).

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A foldable cutting tool, comprising:
a blade structure including a first pivoting member;
a handle structure including a second pivoting member;
a pivoting shaft extending in a first direction and combined with the first pivoting member and the second pivoting member, wherein the blade structure or the handle structure can be turned about an axis in parallel to the first direction to be switched between an unfolded working state and a folded storage state; and
a locking and unlocking structure disposed in a first accommodation space of the handle structure, and rotatable about an axis in parallel to a second direction, wherein the locking and unlocking structure is rotated to a first position to be in contact with a first part of the blade structure to secure the blade structure in the unfolded working state, and the locking and unlocking structure is rotated to a second position different from the first direction to have a retracting part facing a second part of the blade structure, wherein the second part of the blade structure can pass the retracting part of the locking and unlocking structure to enter the folded storage state.

2. The foldable cutting tool according to claim 1, further comprising a lock auxiliary structure disposed in a second accommodation space in the handle structure, wherein the lock auxiliary structure is in contact with the locking and unlocking structure and provides a restoring force to have the locking and unlocking structure rotate toward the first position along a specific direction, and the locking and unlocking structure reaching the first position is in contact with the first part of the blade structure and secured in the unfolded working state.

3. The foldable cutting tool according to claim 2, wherein when the locking and unlocking structure is rotated to the first position, a first surface thereof is in contact with the first part of the blade structure so as to stop the blade structure from rotation, and when the locking and unlocking structure is rotated to the second position, the retracting part faces the second part of the blade structure, and the second part of the blade structure can pass the retracting part to enter the folded storage state.

4. The foldable cutting tool according to claim 3, wherein the second part of the blade structure is an arc part, and a first distance between an outer edge of the arc part and a center of the pivoting shaft is equal to or less than a preset length so that the second part can pass the retracting part and enter the folded storage state when the locking and unlocking structure is at the second position and the blade structure is turning inwards.

5. The foldable cutting tool according to claim 4, wherein the blade structure includes a third part, which is another arc part in contact with the locking and unlocking structure when the blade structure enters the folded storage state, and a second distance between an outer edge of the third part and the center of the pivoting shaft is less than the preset length and also less than the first distance, and wherein the restoring force provided by the lock auxiliary structure to the locking and unlocking structure drives the locking and unlocking structure to rotate along the specific direction, so that the retracting part is in contact with the third part of the blade structure to secure the folded storage state.

6. The foldable cutting tool according to claim 1, wherein the handle structure includes a first handle portion with the first accommodation space and a second handle portion with the second accommodation space, and the lock auxiliary structure includes a push member and a resilient member, wherein a third surface of the push member is in contact with a fourth surface of the locking and unlocking structure, and the resilient member urges the push member to push against the locking and unlocking structure, thereby driving the locking and unlocking structure to rotate toward the first position along the specific direction, wherein the locking and unlocking structure is rotated to the first position to be in contact with the first part of the blade structure to secure the blade structure in the unfolded working state.

7. The foldable cutting tool according to claim 6, wherein a spiral plane or an inclined plane is formed on the third surface of the push member, and another spiral plane or inclined plane is formed on the fourth surface of the locking and unlocking structure, which are engaged with the each other so that the resilient member urges the push member to move forwards and push against the locking and unlocking structure and drives the locking and unlocking structure to rotate, wherein the resilient member is a compression spring.

8. The foldable cutting tool according to claim 1, wherein a main body of the locking and unlocking structure is implemented with a cylinder, which has a ratio of thickness to diameter smaller than or equal to 1.

9. The foldable cutting tool according to claim 1, wherein the first pivoting member is a first hole formed in the blade structure, the second pivoting member is a second hole formed in the handle structure, the pivoting shaft penetrates through the first hole and the second hole along the first direction, and the blade structure or the handle structure can be turned about the pivoting shaft, wherein the second direction is substantially perpendicular to the first direction.

10. The foldable cutting tool according to claim 1, wherein the locking and unlocking structure is disposed in the handle structure close to an end, and disposed near the pivoting shaft.

11. The foldable cutting tool according to claim 10, wherein the locking and unlocking structure is disposed at a position where the locking and unlocking structure can be in contact with a tail surface of the blade structure when the blade structure is in the unfolded working state.

12. The foldable cutting tool according to claim 1, further comprising a lock auxiliary structure, wherein the lock auxiliary structure is a torsion spring disposed in a second accommodation space and contact with the locking and unlocking structure, and the torsion spring provides a restoring force to the locking and unlocking structure to have the locking and unlocking structure rotate in a specific direction toward the first position.
